(19) United States
(12) Patent Application Publication
(10) Pub. No.: US 2007/0256351 A1
(43) Pub. Date: Nov. 8, 2007

(54) Device and method for converting a container into an insect trapping device

(76) Inventor: Leslie Alan Milton, Naperville, IL (US)

Correspondence Address: DENISON & ASSOCS. PC, 212 W. WASHINGTON ST, #2004, CHICAGO, IL, 60606, US

(21) Appl. No.: 11/076,191

(22) Filed: Mar. 8, 2005

(51) Int. Cl. A01M 1/06

(52) U.S. Cl. 43/139; 43/132.1

(57) ABSTRACT

An insect trapping device that utilizes an air, water, and light tight container, a centrifugal blower, an insect attractant including, but not limited to, a prism which diffracts light from a translucent light source and a supply of compressed carbon dioxide gas possibly mixed with a tracer gas providing an odor for safety during travel and storage. The insect present invention is further provided with a plurality of apertures through which insects may enter the device, and a weather protector to protect the present invention from natural elements. The insect present invention is further provided with an electricity source and a button for initiating the electricity, and therefore, the gas supply provided from a compressed gas cylinder. The insect present invention is further provided with a support stand for stability on uneven surfaces. The container can contain a bag with a stabilizing insert for safe, easy, sanitary, and efficient disposal of trapped insects.

### FIELD OF THE INVENTION

The present invention relates to the field of insect trappers, and more particularly those that use a prismatic light, centrifugal blower, and additional insect attractants, such as a carbon dioxide gas from a pressurized gas container and ocetenol tablets.

### BACKGROUND OF THE INVENTION

Currently, in the marketplace, there are available a wide variety of insect trapper device designs which may rid insects from the immediate environment. Oftentimes, an insect carries pathogens and can transfer the pathogens either by biting the human victim or by merely coming in contact with the victim. Not only is there a threat to safety when an insect is in the immediate presence of a human, but they can make annoying noises and/or be a great annoyance when they alight on the skin's surface. It is desirable, therefore, to prevent contact with pathogen bearing insects as rid the immediate environment of them.

By using an insect trapper which utilizes carbon dioxide, diffracted light, and preferably a tracer gas adaptable to any common container vessel such as a garbage can, steel drum, and buckets, a convenient and environmentally safe alternative exists to sitting in an insect infested location. In reviewing the prior art, there are a number of insect trappers that have, in one way or another, been developed to remove insects from the environment. For example, U.S. Pat. No. 6,286,249, issued to Miller, et al, and PCT Application WO 98/11774 filed by Miller, et al, utilizes a fan mechanism, a CO₂ device, an air flow channel funnel position at the upper portion of the device with the fan at the bottom portion of the device. However, this particular device lacks a plurality of entrance holes, a light attracting device, and a centrifugal blower. Nonetheless it is illustrative of a plurality of devices that utilize fans and other mechanisms to suck mosquitos into a trapping device. Of course, other methods for employing suction or air movement may be employed by those skilled in the art to trap unwanted flying insects.

Another issued patent, U.S. Pat. No. 6,272,790 issued to Paganessi, et al. discloses the use of a CO₂ supply which is metered through a tubing fence and dispensed into the center of a plurality of traps that serve as visual targets for insects. Similarly, this device also lacks a plurality of entrance holes, a light attracting device, and a centrifugal fan. Another patent, U.S. Pat. No. 6,199,316, issued to Coventry, discloses a device having a pressure vessel and a restrictor tube which is connected to a supply of compressed gas via a valve. The Coventry disclosure utilizes a centrifugal fan to pull the trapped insects into the dark, air tight container to assist in blowing insects into a tray of chemicals.

U.S. Pat. No. 6,055,766, issued to Nolen, discloses the use of an apparatus which simulates a host animal with heat and an electrified grid, elements. Still another patent, U.S. Pat. No. 5,813,166, issued to Wigton, discloses the use of a trap system for preventing the entry of mosquitos into a predefined area. This particular disclosure does not show the use of a plurality of circular entrance holes, a diffused or diffracted light attracting device or a centrifugal fan. Yet another patent, U.S. Pat. No. 5,205,064, issued to Nolen, discloses the use of an insect attracting and trapping device having a charged cannister with CO₂, ocetenol, a combination thereof, or insect pheromones, in combination with infrared and/or ultraviolet lights which are surrounded by an electrified grid. The gas is only discharged periodically to attract insects.

Still a more recent patent, U.S. Pat. Publication 2004/0200135, filed by Miller, discloses a device for attracting and capturing insects including a fan mechanism, an entrance funnel, which is similar to the Nolen patent discussed above. A further patent publication U.S. Pat. Publication 2004/0123512, filed by Spiro, discloses the use of an insect trapping apparatus utilizing CO₂ as an insect attractant, a heat source and further a blue light. However, this device still does not have a plurality of entrance holes or centrifugal blower. Another patent application, U.S. Pat. Pub. 2004/0103579, filed by Nolen, discloses an improved method for providing an insect gaseous product into an insect trap by using an ozone producing unit and activated carbon for feeding to an insect trap. Nolen believes this use of ozone and activated carbon to be superior to the use of CO₂ alone.

U.S. Pat. No. 5,799,436, also issued to Nolen, discloses a device for attracting and destroying insects including a housing, a source of ocetenol to mix with carbon dioxide within the housing for release to attract insects. The Nolen device does not contemplate use of the carbon dioxide alone, and in fact, teaches away from the use of carbon dioxide alone. Nor does it contemplate the carbon dioxide being combined with a different tracer gas, and it further teaches the use of heat and an electric grid. In addition, the Nolen device does not disclose the use of light as an attractant nor a centrifugal blower.

Another patent, U.S. Pat. No. 4,625,453, issued to Smith, is an apparatus for capturing insects disclosing a closed container, with a centrifugal blower an inlet filter to the blower which creates sufficient air flow at the device's inlet that it provides a means to trap insects. The Smith device utilizes suction to capture insects, however it does not teach a variety of techniques including both suction and a gas asphixiont to trap and destroy insects.

Gillies, M. T., in The role of carbon dioxide in host finding by mosquito's (Diptera:Culcidae): a review. Bull. Ent. Res. 70:525-532 (1980), provided an explanation of the benefits of carbon dioxide in accelerating a mosquito's flight pattern and attracting an insect initially. Specifically, the article illustrates that a pulsed stimulus moving upstream, as is the carbon dioxide provided by the present invention via the centrifugal blower, results in upwind displacement of the interested mosquito.

The following devices introduce carbon dioxide in a variety of different manners. For example, U.S. Pat. No. 2,661,512, issued to Kretschmar, uses a portable pressurized cylinder of carbon dioxide, not as an insect killer, but as a fire protection suppression means. U.S. Pat. No. 4,506,473, issued to Walters, discloses a method of generating carbon dioxide from salts and acids which may expose users to hazardous materials. Accordingly, the Walters device is not environmentally safe, per se.

Another patent, U.S. Pat. No. 4,519,776, issued to De Yoreo, discloses a method for generating carbon dioxide from propane and is a stand alone carbon dioxide generator. Again, the environmental concerns regarding the use of propane would present an issue for many environmentally conscious users. Likewise, U.S. Pat. No. 4,907,366, issued to Balfour, discloses the use of dry ice as a source of carbon dioxide which could also be used as a source of carbon dioxide along with the present invention. Dry ice, however, provides a hazard to exposed skin of the user, and it is not readily available to most prospective users of an insect trapping device. Further, U.S. Pat. No. 5,382,422, issued to Dieguez, uses liquid carbon dioxide and discloses a method of mixing the aforesaid carbon dioxide with insect attractants to maintain the chemical composition.

The Jackson reference, U.S. Pat. No. 3,796,001 also discloses an interesting weatherproof insect trapping device which contains a truncated cone, a light source and a fan for the purposes of trapping insects onto a screen. The mosquitos enter the truncated cone portion through an aperture in the bottom of the device. The air draft is carefully regulated to be sufficiently strong to pull mosquitoes through the entryway aperture. A damper may further be provided to control the flow of air.

Brett (1938) On relative attractiveness to Aedes aegypti of certain coloured cloths, Trans. Roy. Soc. Trop. Med. Hyg. 32: 113-124, established the presence of color preference in Aedes Aegypti by exposing mosquito's to different colored cloths. Thereafter, Gjullin C. M. (1947) Effect of clothing color on the rate of attack of Aedes mosquitoes, J. Econ. Entom. 40: 326-27, counted Aedes mosquito's landing on the back of different shirts worn by one man to prove that the order of attractancy, in descending order, block, blue, red, tan, green, yellow, and white. Brett, supra, and Gjulllin, supra, both provide the basis for the present invention's use of a grooved prism design, in combination with a translucent light source, to diffract and disperse the light in a spectrum of colors in the insect attractant.

In addition, Rudolfs Wilhelm (1922) Chemotropism of Mosquitos, New Jersey Agr. Exp. Sta. Bull. 367, tested numerous substances as possible attractants for mosquitos using an apparatus with two chambers and a connecting glass tube. Positive responses were elicited from ammonia and peptone. Further, Takken and Kline (1989), J. Am. Mosq. Control Assoc. 5(3): 311-16, used ocetenol to attract flies. Ocetenol has been shown to attract numerous different species of insects as well. Further, when ocetenol is used together with carbon dioxide, additional species of mosquitos are attracted despite each being capable of attracting the mosquitos on its own. Incorporating the teachings of the prior art, the present invention provides that either ocetenol, ammonia, carbon dioxide, or a combination may be utilized as an insect attractant.

Thus, nowhere in the prior art is a combination of a dark air tight container for holding the trapped insects, a centrifugal blower, a translucent light source, a low pressure drop inlet filter, a light source, an insect attractant with a plurality of entrances, and a light diffracting prism with light reflecting and diffusing nozzles for trapping and destroying insects. Such a device would be easily manipulated, inexpensive, and convenient device for attracting and killing insects.

### SUMMARY OF THE INVENTION

The present invention comprises an insect trapping device which, when attached to a simple non-light emitting air tight dark color container including, but not limited to a bucket, trash can, steel drum, and the like, it can perform the function of a lid. The insect trapping and disposal device is provided with a centrifugal blower, a translucent light bulb protector, a low pressure drop inlet filter, a light source, an insect attracting device consisting of multiple circular entrances that can hove ocetenol tablets placed therein, a grooved light diffracting prism with light reflecting diffusing insert, a flying insect flight director, and a compressed gas inlet pipe and gas directing nozzles. A disposable trash bag with a reusable/replacement trash bag retainer can be used inside the container to collect and dispose of the insects debris hygienically. The present invention is attached to the container with a simple band clamp which provides a light and air tight seal.

Carbon dioxide gas, from a pressurized source, can be introduced at predetermined times of the day at a regulated flow. The gas can be pure or a mixture of carbon dioxide and a tracer gas. The tracer gas provides the carbon dioxide gas with a smell so as to increase the safety during transportation and storage of the cylinder in confined spaces. The tracer gas can consist of, but is not limited to, gases such as ammonia, ocetenol, or gases with other similar odors. Moreover, the power for the light and centrifugal blower is supplied from a ground protected 110 V supply via a 3 core power cable. The electrical means may also be presented as a low voltage option. The insect trapping and disposal device is further provided with a weather protecting covering fitted to protect the insect trapping and disposal device entrance and electrical powered equipment from the weather.

The insect trapping and disposal device, along with the simple container, is intended for use in either outdoors or well ventilated areas. Depending on the size of the container used, it is expected that the container be emptied when the compressed gas cylinder is changed. The invention does not use propane, or have an open flame, and therefore, is suitable for unattended use outdoors in a garden, park, or field; or in a well ventilated industrial, agricultural, or horticultural environment. Care should be taken to ensure that concentrations of carbon dioxide gas in the air do not exceed the concentrations set by OSHA (800 ppm/8 hours).

The foregoing disclosure taken together with other features and advantages of the present invention can be readily derived from the following detailed description of the drawings taken in conjunction with the accompanying drawings present herein, and should be considered as within the overall scope of the invention.

### OBJECTS OF THE INVENTION

Thus, it is one primary object of the present invention to provide a non-flammable insect trapping device that does not use flames and it uses any combination of the following; a grooved prism, a translucent light source, a carbon dioxide source, and ocetenol.

It is yet an additional primary object of the present invention to provide an easy and convenient method of trapping insects by using an available simple container such as a conventional dark, light resistant garbage can.

It is still a further primary object of the present invention to provide a tracer gas which, when mingled with the carbon dioxide, produces a distinct odor providing safety when transporting and storing the device.

Yet a further primary object of the present invention to provide a weather protective covering to supply longevity to the device where in the weather protective covering consists of a weather and rust resistant material.

Another primary object of the present invention is to provide versatility to the user regarding location of use by providing an electrical means with a low voltage, 110 volt option, and an extension cord.

Additionally, it is primary object of the present invention to provide a hygienic method of disposing of the trapped insects by providing which a container, such as a garbage can which is adapted to receive a bag, which when full, can be easily, hygienically, and efficiently disposed of.

Still another primary object of the present invention is to provide a new method for reducing the number of insect bites by reducing the numbers of insects by providing a better insect attractant containing any combination of a carbon dioxide source, a translucent light source, a grooved prism, and an ocetenol tablet; and a plurality of entrance holes which allow more diffracted light into the environment thus controlling the entry flight of the insect to the device.

Another primary object of the present invention is to provide an environmentally friendly method of trapping insects; as opposed to chemical methods by providing both a carbon dioxide source which can readily escape harmlessly into the environment, and diffracted light.

Yet another primary object of the present invention is to provide an affordable insect present invention because it is made out of what that is inexpensive or what that is easy to manufacture.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 is a back perspective view of one embodiment of the present invention.

FIG. 2 is a side elevational cross sectional view of one preferred embodiment of the support columns of the present invention.

FIG. 3 is a front perspective view of one preferred embodiment of the present invention.

FIG. 4 is a side cross sectional and elevational view of the cross section of one preferred embodiment of the insect attractant of the present invention.

FIG. 5 is a side elevational and cross sectional view of a preferred embodiment of the present invention.

FIG. 6 is a side elevational and perspective view of a preferred embodiment of the gas supply line and cylinder of the present invention.

FIG. 7 is a side perspective view of a preferred embodiment of the container of the present invention.

### DETAILED DESCRIPTION OF THE DRAWINGS

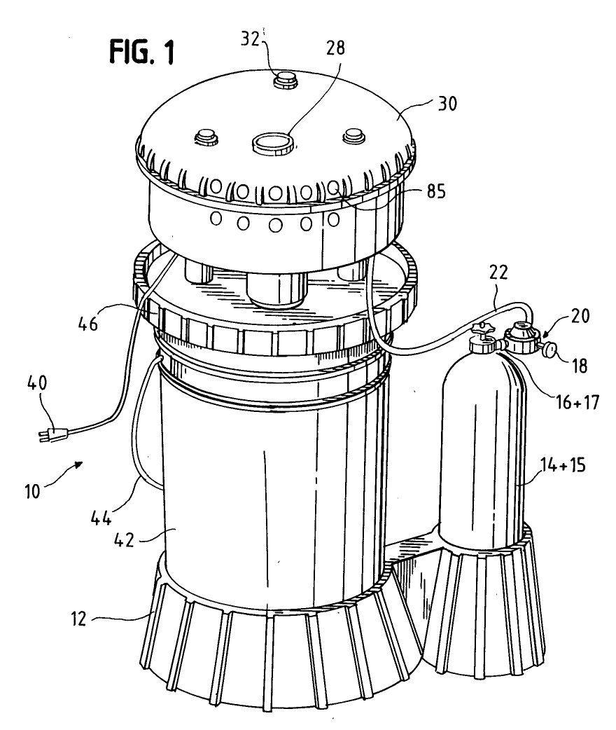

Shown now in FIG. 1 is a back side perspective view of the present invention insect trapping device 10. In this particular preferred embodiment, the body 12 has a container side and an electric side. The body 12 is removably attached to a container 14 on the container side. The container 14 may include, but is not limited to: a bucket, trash can, or steel drum. Further, the container 14 is dark in color, non-light emitting, and air tight. In this preferred embodiment, the container 14 also has a handle 16. The present invention insect trapping device 10 is also provided with a support stand 18 which has a first 20 and a second 22 side. The container 14 is adopted to be securely received by the first side 20 of a support stand 18 while the second side 22 of the support stand 18 is similarly adapted to securely receive a compressed gas cylinder 24. In this way, the support stand 18 provides stability for the present invention insect trapping device 10 when placed on an uneven surface. The second side 22 of the support stand 18 is further provided with a display 19 which indicates whether the cylinder 24 is empty or full according to the pressure on a cantilever platform which is contained within the second side 22 of the support stand 18, and upon which the cylinder 24 is adapted to reside. The cantilever measures the weight of the carbon dioxide gas cylinder 24 and converts the weighted result to a reading of empty or full which is visualized through the display 19.

Also shown in FIG. 1 is the quick release external connector and check valve 26 of the cylinder 24, which is connected to the internal connector 28, and the fixed flow pressure gas regulator 30. Unless and until the external 26 and internal 28 connectors are securely mated, one within the other, there is no gas flow, thereby providing a safety feature when transporting the present invention insect trapping device 10. The regulator 30 is further provided with a pressure gauge 32 which, like the display 19, indicates a gage of the remaining contents of the cylinder 24. The fixed flow pressure gas regulator 30 is connected to a flexible gas supply line 34. A tracer gas may be provided along with the carbon dioxide in the cylinder 24 so that leakage of the gas may be detected by scent. The detecting tracer gas may include, but is not limited to, ammonia, ocetenol, or other suitable marker gases.

A centrifugal blower axial inlet duct 36 is adjacently located and contained within the body 12. The axial inlet duct 36 is preferably made from a non-light emitting material. Additionally, a weather protector 38 is affixed to the body 12 on the electric side by support means 40. Further, the weather protector 36 is preferably a non-light emitting dark color. The present invention insect trapping device 10 is provided with exhaust air outlet ports 42 adjacently located beneath the weather protector 38. The outlet ports 42 are provided with exterior screens. On the top portion of the weather protector 38 is located a button 44 which, when depressed, initiates compressed gas flow. The present invention insect trapping device 10 is activated by electrical current provided through an electrical connection means 46 which can include, but is not limited to, a simple cord and plug system and an electrical connection point. The electrical connection means is preferably provided with a water proof extension cord to protect from mechanical damage by using a split cable protector.

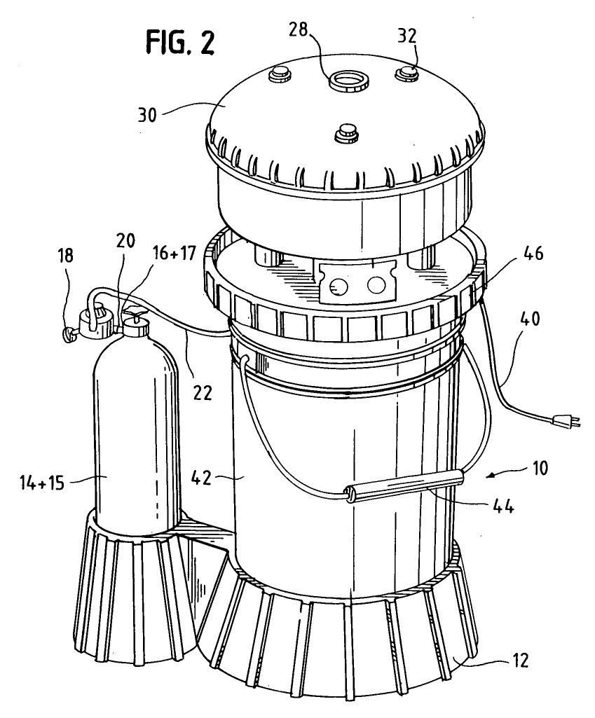

FIG. 2 illustrates a broken away front cross sectional and elevational view of a preferred embodiment of the present invention insect trapping device 100 in which the weather protector 138 is affixed to the body 112 by support means 140. In this particular preferred embodiment, the weather protector 136 is provided with at least one aperture 142 adapted to receive a column 144. The column 144 has a first portion affixed to the lid of the body 122 at one end 146 with a nut and bolt or other fastening element in this particular embodiment, and is provided with a nut and bolt or other fastening element for affixing the second end 148 to the weather protector 138 although other commonly available fastening means may be used, which are readily available in the marketplace.

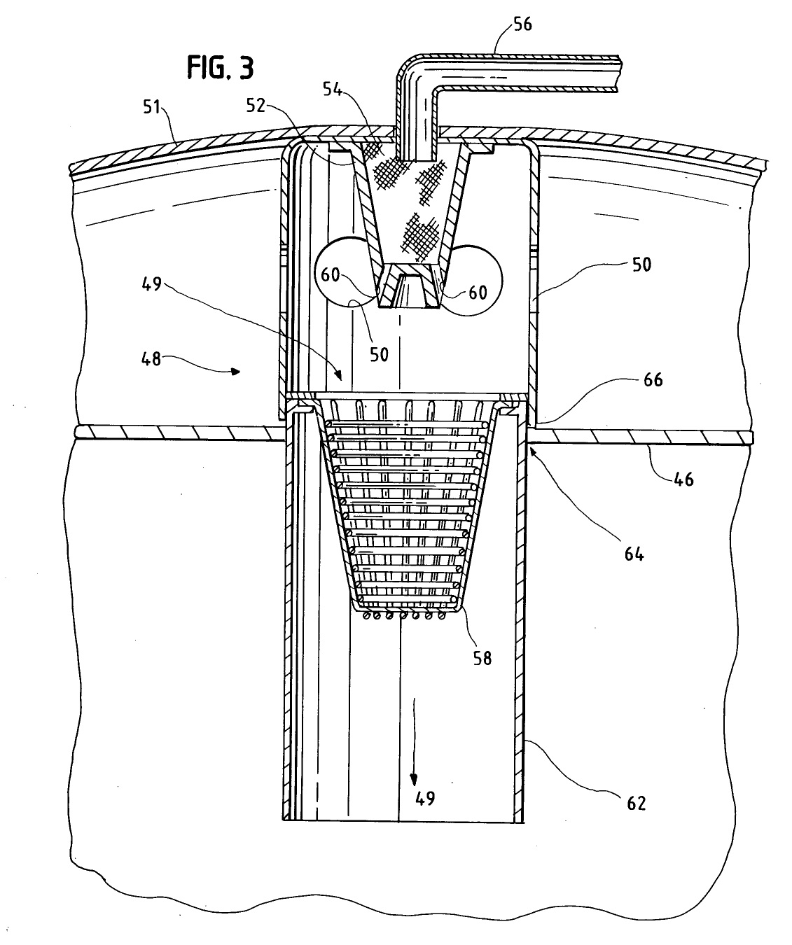

FIG. 3 is a front perspective view of the present invention insect trapping device 200 with a body 212 affixed to the container 214. The body 212 has an insect attractant 216 located on, and retained by, the electrical side. The insect attractant 216 may be, but is not limited to, a translucent material with a plurality of apertures 218 through which an insect may enter the insect attractant 216. The insect attractant 216 is further provided with a small weather protector 220 to protect the apertures 218 from the elements. The body 212 is sealed by a lid 222 on the electrical side to provide a means for retaining the insect attractant 216 and through which the support means 224 can fixedly attach the weather protector 228 to the insect trapping device 200 and the body 212.

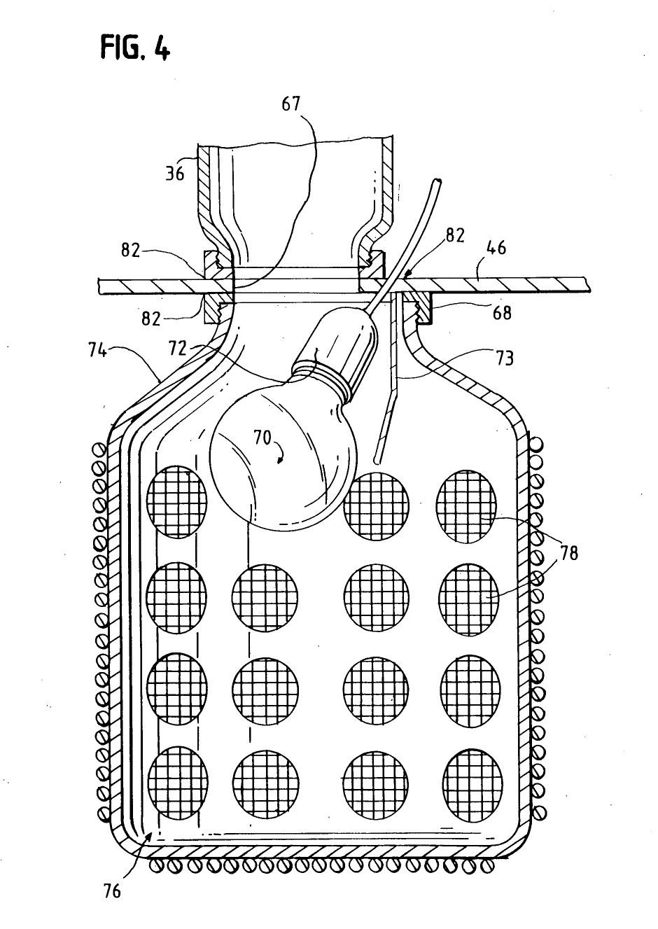

FIG. 4 illustrates a front elevational and cross sectional view of another preferred embodiment of the present invention, insect trapping device 300 depicting the insect attractant 316, also seen at 216 in FIG. 3, which has an upper and lower portion. The small weather protector 320 is adjacently affixed to the insect attractant portion 316. The insect attractant portion 316 is provided with a plurality of apertures 318 through which the insect may enter. The apertures 318 may be provided with an ocetenol tablet 317 mounted near the openings to introduce an ocetenol smell at the entrance to further attract the insects. At the upper portion of the insect attractant 316 is affixed a light diffracting prism 322 containing therein a light reflecting/diffusing insert 324. The prism 322 securely retains a compressed gas inlet pipe 326 through which compressed gas enters the prism 322. The compressed gas then exits the prism via a plurality of compressed gas exit nozzles 328. The lower portion of the insect attractant 316 feeds directly into a truncated aperture 332 provided in an insect directing tube 330. The insect directing tube 330 is retained by the lid 329 in an air, water, and light tight seal 332. The insect attractant 316 and the insect directing tube 300 are also provided with an air, water, and light tight seal 334. In this particular embodiment the truncated aperture 332 is a cone. The truncated cone aperture 332 is at a 60 degree minimum angle and may be made from a solid surface or insect screen.

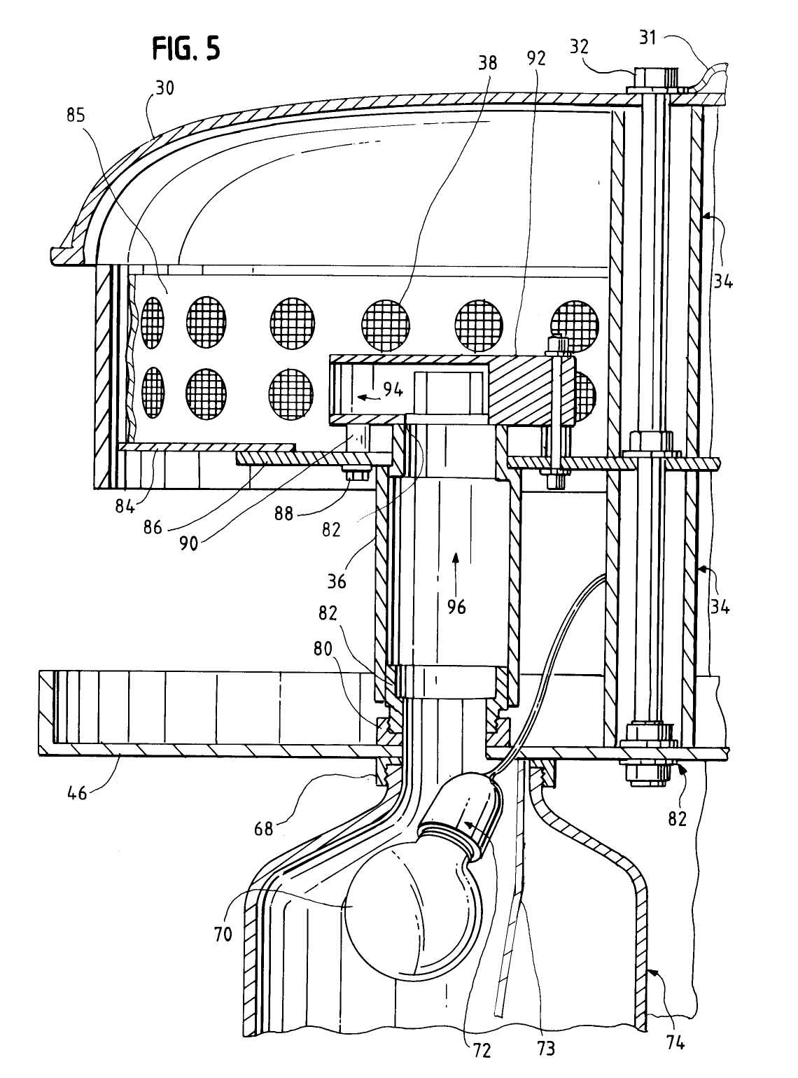

FIG. 5 shows a side elevational and cross sectional view of another preferred embodiment of the present invention insect trapping device 400 illustrating the centrifugal blower axial inlet duct 450 of the centrifugal blower 452, as seen at 36 in FIG. 1. The centrifugal blower 452 is provided with a bolt means 453 that may include, but is not limited to, a bolt and washer that securely retains the centrifugal blower 452 affixed to a mounting plate 454 which is provided within and extending interiorly from the interior portion 456 of the weather protector 458. The second end 448 of the column 444 provides suspension and stability to the mounting plate 454.

The centrifugal blower 452 is affixed to the mounting plate 454 such that the inlet duct 450 is suspended therefrom. The lower portion of the inlet duct is threadingly received by a threaded seal 460 which adjacently rests upon the lid 462. The seal 460 provides an air, water, and light tight seal. There is a handle 464 retained by the upper exterior portion 446 of the weather protector 458. The ergonomic handle 464 can be either integral to the exterior portion 446, or fixed thereto by means commonly available in the art. Further, in one preferred embodiment, the handle 464 can be supported and retained by the second end 448 of the column 444. The handle 464 can be ergonomically shaped to provide a comfortable way to move the present invention insect trapping device 400. The inlet to the centrifugal blower 452 is axial and vertical to the lid 462. The centrifugal blower is also provided with an exhaust outlet 466 opposed to the inlet 450. The outlet 466 is provided with an aperture opening into the weather protector 458. The outlet 466 can also be viewed at 42 in FIG. 1. The outlets are further provided with an outlet screen.

Also in FIG. 5 is shown an interconnecting throughway between the inlet 450 and the light bulb protector 468. The light bulb protector contains a weatherproof lamp holder 470 which may threadingly receive a light bulb 472. A bracket 474 positions the light bulb 468 immovably in place. The light bulb 468 provides light that can be diffracted by the prism, as seen at 322 and 324 in FIG. 4.

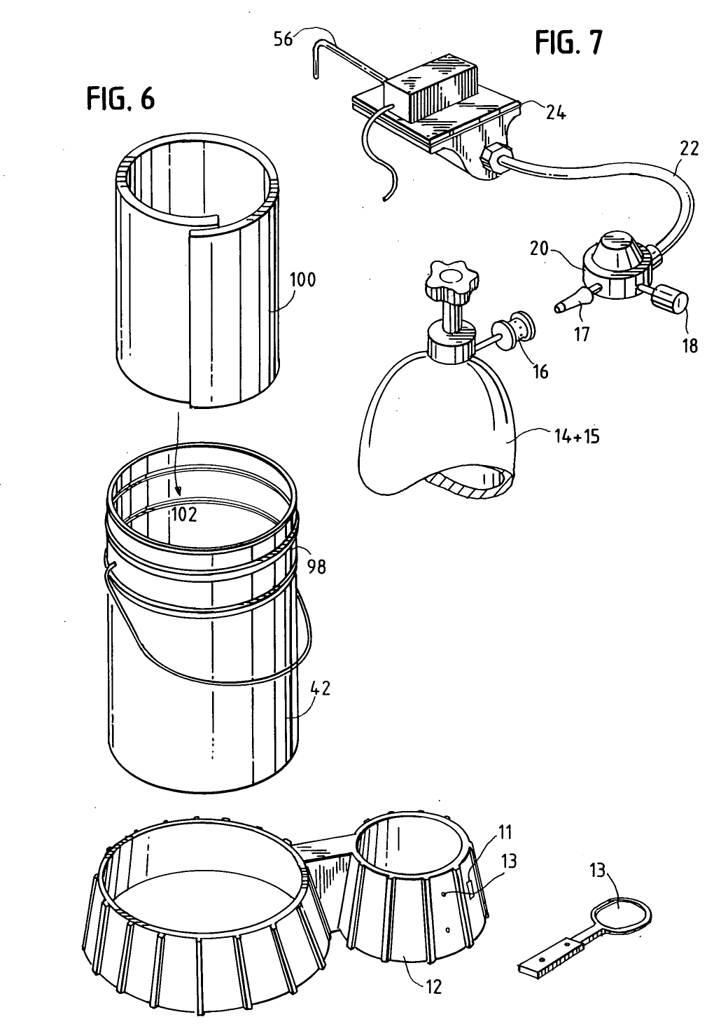

FIG. 6 shows a side perspective broken away view of the regulator 500 and cylinder 502 of the present invention. The external connector 504 is adapted to receive the internal connector 506 which protrudes from the regulator 508. Also protruding from the regulator 508 is the pressure gouge 510 and one end of the flexible supply line 512. A second end of the flexible supply line feeds into, and is connected to a solenoid valve 514 which switches the supply of compressed gas on and off as required. The outlet 516 of the solenoid valve 514 is connected to the compressed gas inlet pipe 518 which provides gas to the insect attractant, seen at 326 in FIG. 4. The solenoid valve 514 is provided with at least two timers, a hold on relay timer, and a push button. When the user requires compressed gas, the button is depressed, as seen at 44 in FIG. 1, which initiates a hold relay and timer set for a predetermined time. Electrical power is then provided to both timers which pulse the solenoid valve 514 at a predetermined on and off timed rate. The compressed gas will continue to flow until the hold timer relay times out and the compressed gas flow will stop until the button is again depressed.

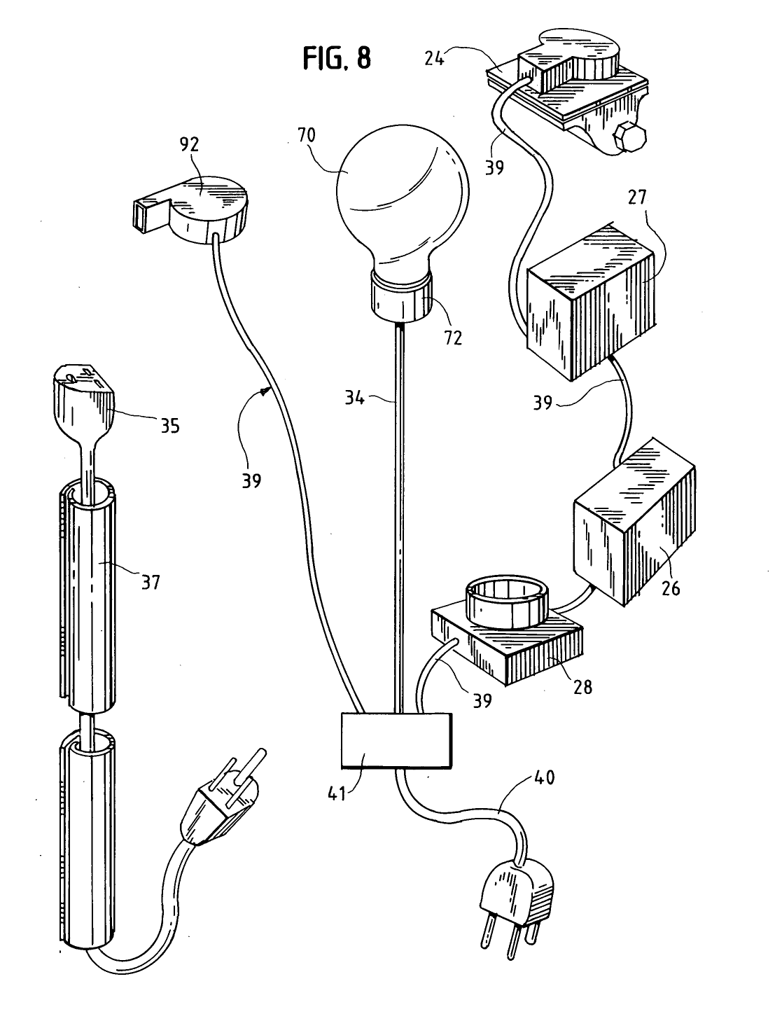

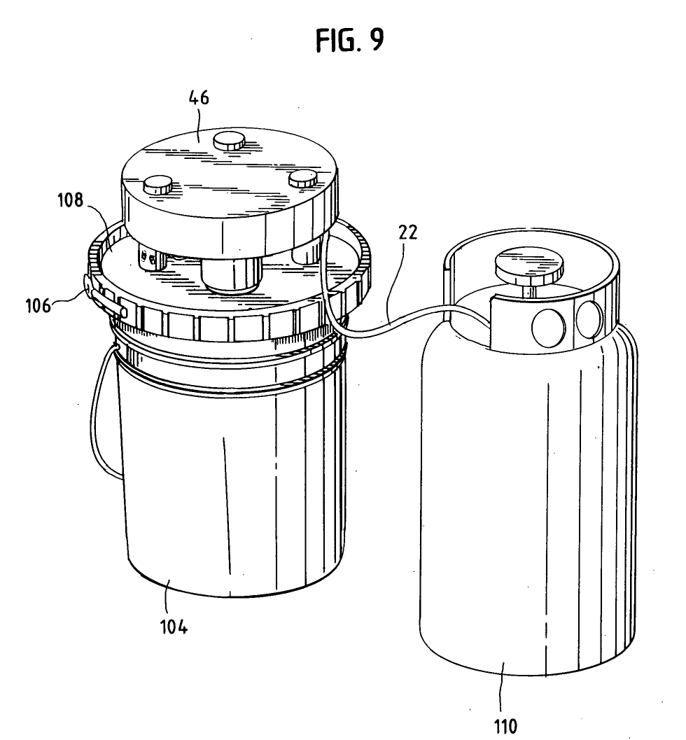

FIG. 7 is a side perspective view of the container 600 of the present invention which has an interior portion. In this preferred embodiment, the interior is fitted with a conventional garbage bag 602 which can be held in place by inserting within the interior of the bag 602 a stabilizing insert 604 to hold the bag in place. The bag 602 can be removed from the container 600 and discarded thereby providing a sanitary, convenient, and easy means by which destroyed insects can be disposed of.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

I claim:

1. I claim an insect trapping and disposal device comprising;
a body with a first and second portion;
a container with a lid which is securely retained within the first portion;
an insect attractant;
a centrifugal blower;
a plurality of entrance apertures; and
a low pressure drop inlet filter.

2. The insect trapping and disposal device as claimed in claim 1, wherein the container is further provided with a bag.

3. The bag of claim 2 further provided with a stabilizing insert.

4. The insect trapping and disposal device as claimed in claim 1, further provided with a weather protector having screened exhaust air outlet ports.

5. The insect trapping and disposal device as claimed in claim 1, further provided with a button to initiate compressed gas flow.

6. The insect trapping and disposal device as claimed in claim 1, further provided with means for electrically engaging the present invention.

7. The insect trapping and disposal device as claimed in claim 1, wherein the insect attractant is adopted to receive a compressed gas supply tube.

8. The compressed gas supply tube of claim 7 further adapted to connect a directing tube.

9. The directing tube of claim 8 further maintaining an air, water, and light tight seal with the lid.

10. The insect trapping and disposal device as claimed in claim 1, further provided with a first and second portion of a support stand.

11. The first portion of the support stand as in claim 10, which is adapted to removably receive the container.

12. The insect trapping and disposal device as claimed in claim 1, wherein the insect attractant is composed of one or more groups of the following; a carbon dioxide source, a translucent light source, a grooved prism, and ocetenol.

13. The carbon dioxide source of claim 12 further consisting of one or more groups of the following; dry ice, chemicals, a propane and carbon dioxide generator, and liquid carbon dioxide.

14. The second portion of the support stand as in claim 10, which is adapted to removably receive a compressed gas cylinder.

15. The second portion of the support stand as in claim 10, further comprising a display.

16. The second portion of the support stand as in claim 10, further provided with a cantilever.

17. The compressed gas cylinder as in claim 12, further provided with an external connector removably connected to a internal connector protruding from a regulator with a gouge.

18. The compressed gas cylinder as in claim 12, containing carbon dioxide.

19. The compressed gas cylinder as in claim 12, containing carbon dioxide and a tracer gas.

20. The compressed gas cylinder as in claim 17, wherein the tracer gas is selected from one or more groups of odorous gases; ocetenol, ammonia, and any other odorous gas.

21. The insect trapping and disposal device as claimed in claim 1, wherein the weather protector is provided with an means for providing electrical connections to the device.
